(19) United States
(12) Patent Application Publication
(10) Pub. No.: US 2005/0028339 A1
(43) Pub. Date: Feb. 10, 2005

(54) Hydraulic well casing repair system and method therefor

(76) Inventor: Sergio Arturo Leon, Hermosillo (MX)

Correspondence Address: WEISS & MOY PC, 4204 NORTH BROWN AVENUE, SCOTTSDALE, AZ, 85251, US

(21) Appl. No.: 10/829,906

(22) Filed: Apr. 23, 2004

(30) Foreign Application Priority Data
Aug. 6, 2003 (MX) PA/U/2003/000203

(51) Int. Cl. B23P 19/02; B23P 6/00

(52) U.S. Cl. 29/402.09; 29/402.11; 29/402.08; 29/801; 29/235

(57) ABSTRACT

A hydraulic well casing repair system and method therefor. Pressurized fluid from an above-ground source is provided to a hydraulic swage body inside a well. The swage body comprises at least one movable member for exerting laterally outward pressure on the well casing. Rigid segmented concentric tubing communicates pressurized fluid to the swage body.

### RELATED APPLICATION

This application is related to a Mexican patent application, number Pa/u/2003/0000203, filed Aug. 6, 2003, entitled “MEJORAS A PRENSA CIRCULAR PARA REPARACION DE ROTURAS EN POZOS PROFUNDOS,” from which this application claims priority.

### FIELD OF THE INVENTION

This invention relates generally to well casing repair, and more particularly, to a hydraulic swage system and method for repairing well casings.

### DESCRIPTION OF THE RELATED ART

Well shafts typically are lined with metal casings which may become bent or damaged. Typically, these casings are repaired by lowering a swage having expandable metal-forming surfaces into the well to the damaged portion, and operating the swage to expand outward to bend the damaged portion to its original position. Often a liner is then lowered to the damaged portion and the swage operated again to press the liner into position over the damaged portion as a patch.

Swages commonly used for well casing repair require an above-ground power source and a power line running to an electric motor located in the swage. Typically, the motor drives a hydraulic pump, also located within the swage, which uses hydraulic pressure to operate the metal-forming surfaces. Because the electric power must be transferred from a surface supply down into a well, significant voltage losses occur in the transmission line. However, because the damage may occur at variable depths, different gauges of transmission lines are often required to ensure sufficient power is transmitted to the motor.

Furthermore, the hydraulic pump must produce pressure of about 10,000 psi to operate the swage, generating excessive heat. The hydraulic pump also typically requires 45 to 60 seconds to develop full pressure to operate the swage, making repair work a tedious process.

Finally, a secondary system is required to raise and lower the swage and position the swage to repair the damaged casing. This is frequently accomplished using a steel cable, shaft, or pipe.

A need therefore exists to provide a system for repairing well casings that does not require varying gauge transmission lines corresponding to different depths of repair. A need also exists to provide a swage for repairing well casings that does not produce excessive heat and that reduces the time required to operate the swage. Finally, a need exists to provide a swage that does not require a first system to provide power to the swage and a second system to position the swage. The present invention satisfies these needs, and provides other related advantages.

### SUMMARY OF THE INVENTION

The foregoing objectives are achieved in the hydraulic well casing repair system and method therefor.

In one embodiment of the present invention, a hydraulic swage system for repairing well casings is disclosed. It comprises in combination: a swage body comprising at least one movable member for exerting pressure laterally outward from the swage body; an above-ground source of pressurized fluid coupled to the swage body; a first tube coupled to both the swage body and to the above-ground source of pressurized fluid so that the pressurized fluid entering the swage body from the first tube moves the at least one movable member laterally outward from the swage body.

In accordance with another embodiment of the present invention, a hydraulic swage system for repairing well casings is disclosed. It comprises, in combination: a swage body defining a cavity and comprising at least one movable member for exerting pressure laterally outward from the swage body; a piston positioned in the cavity and coupled to at least one of the at least one movable member, whereby the piston separates the cavity into a first portion and a second portion; and an above-ground source of pressurized fluid coupled to said swage body. It also comprises a first tube coupled to the first portion of the cavity for coupling the above-ground source of pressurized fluid to the first portion of the cavity and a second tube coupled to the second portion of the cavity for coupling the above-ground source of pressurized fluid to the second portion of the cavity. At least one of the first tube and the second tube comprises a plurality of rigid segments.

In accordance with another embodiment of the present invention, a method of repairing well casings is disclosed. It comprises the steps of: providing a hydraulically operated swage body comprising at least one movable member for exerting pressure laterally outward from the swage body; providing an above-ground source of pressurized fluid; coupling a first end of a first tube to the swage body; lowering the swage body into a well having a casing; supplying pressurized fluid from the above-ground source of pressurized fluid into a second end of the first tube so that the at least one movable member exerts laterally outward pressure on the well casing.

The foregoing and other objects, features, and advantages of the invention will be apparent from the following, more particular, description of the preferred embodiment of the invention, as illustrated in the accompanying drawings.

### BRIEF DESCRIPTION OF THE DRAWINGS

FIG. 1 is an illustration of a hydraulic swage system depicting a block diagram of above-ground components and a partially perspective, partially cutaway view of a hydraulic swage in a well interior having jaws in a closed position in accordance with a preferred embodiment of the present invention.

FIG. 2 is an illustration depicting a perspective, partially cutaway view of the hydraulic swage of FIG. 1 having jaws in an extended position.

FIG. 3 is an illustration depicting a perspective, partially cutaway view of the hydraulic swage of FIG. 1 having jaws in an extended position and a well casing liner.

FIG. 4 is an illustration depicting a cross-sectional lateral view of the hydraulic swage of FIG. 1 having jaws in a closed position and having shaded regions depicting areas of pressurized fluid.

FIG. 5 is an illustration depicting a cross-sectional lateral view of the hydraulic swage of FIG. 1 having jaws in an extended position and having shaded regions depicting areas of pressurized fluid.

### DESCRIPTION OF EMBODIMENTS OF THE INVENTION

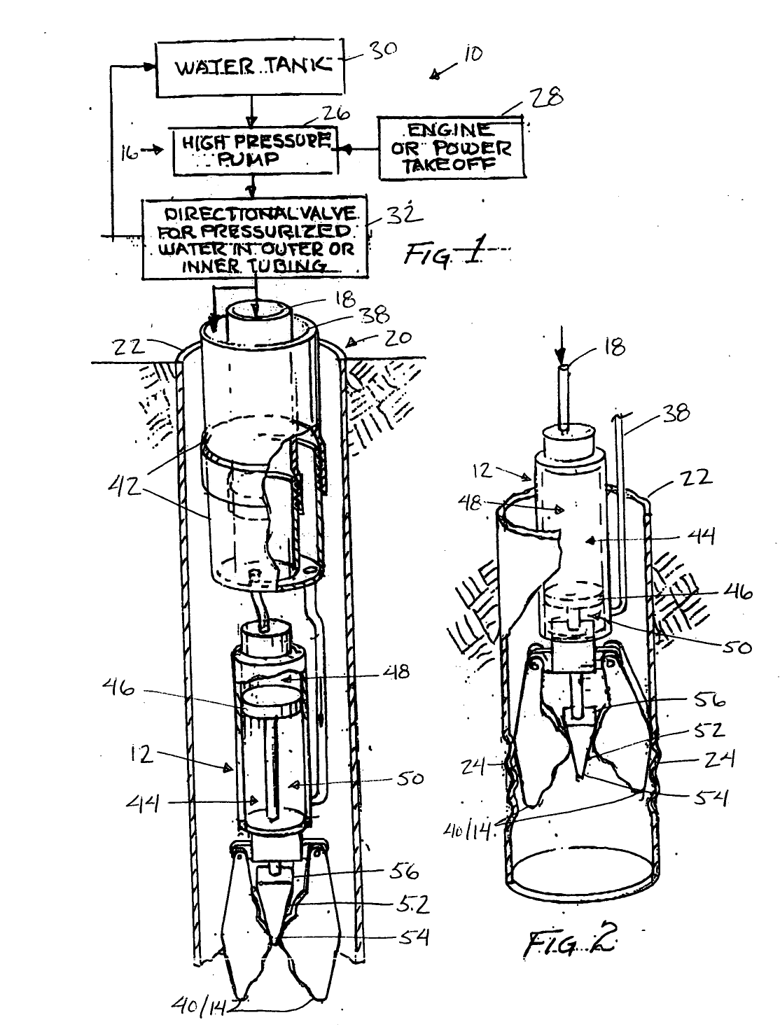

With reference now to the figures, and in particular to FIG. 1, an embodiment of the well casing repair system of the present invention, hereinafter hydraulic swage system 10 is shown. It comprises, in combination: a swage body 12 comprising at least one movable member 14 for exerting pressure laterally outward from the swage body 12; an above-ground source of pressurized fluid 16 coupled to the swage body 12; and a first tube 18 coupled to both the swage body 12 and the above-ground source of pressurized fluid 16 so that the pressurized fluid 34 (shown in FIGS. 4 and 5) entering the swage body 12 from the first tube 18 moves the at least one movable member 14 laterally outward from the swage body 12.

As depicted in FIG. 1, the movable members 14 are in a closed position appropriate for lowering the swage body 12 into a well 20 having a casing 22. When the swage body 12 is positioned at a damaged portion 24 of the casing 22, as depicted in FIG. 2, pressurized fluid 34 from the above-ground source 16 is directed into the first tube 18 and conveyed into the swage body 12, causing the movable members 14 to expand outward. The movable members 14 contact the well casing 22 and apply pressure sufficient to substantially straighten or flatten the damaged portion 24, which may be bent or buckled.

The above-ground source of pressurized fluid 16 shown in FIG. 1 preferably comprises a high-pressure pump 26 and a fluid reservoir 30. Because wells may frequently be located in remote locations with unavailable or unreliable electrical service, the high-pressure pump 26 is preferably powered by a power supply 28 which may be an engine or power takeoff. Although in the present embodiment the above ground source of pressurized fluid 16 comprises a high-pressure pump 26 and a fluid reservoir 30, it should be understood that substantial benefits may be obtained by the above-ground source of pressurized fluid 16 not comprising a high-pressure pump 26 and a fluid reservoir 30, as long as the above-ground source of pressurized fluid 16 provides fluid of sufficient pressure to enable the movable members 14 to repair a damaged portion 24 of a well casing 22. For example, the above-ground source of pressurized fluid 16 may be a container of pressurized fluid or a water tower. Additionally, it should be understood that it is within the spirit and scope of the present invention that the power supply 28 of the high-pressure pump 16 not be an engine or power takeoff, as long as the power supply 28 provides sufficient power to operate the high-pressure pump 16; for example, the power supply 28 may be a standard residential or industrial electrical supply such as a 220 Volt line.

Preferably, both the pressurized fluid 34 and non-pressurized fluid 36 (see FIGS. 4 and 5) of the system of the present invention is water. Water provides the benefits of being relatively abundant and inexpensive. However, it should be understood that substantial benefits may be obtained by not using water and instead using other fluids such as oil or any other fluid capable of use in hydraulic operation.

By providing pressurized fluid 34 from an above-ground source of pressurized fluid 16, the hydraulic swage system 10 of the present invention provides substantial advantages over other currently-employed well casing repair systems. One advantage is that the deeper a damaged portion 24 of a well casing 22, the larger the pressure of the pressurized fluid 34 at the swage body 12 due to gravity, increasing the efficiency of the hydraulic swage system 10. In contrast, conventional techniques that provide electrical power from an above-ground power supply to a motor in a swage body suffer a loss of efficiency at increased depths due to voltage losses in the transmission lines. Another advantage of the hydraulic swage system 10 of the present invention is that an above-ground supply of pressurized fluid 16 may use a substantially larger and more powerful power supply 28 for the high-pressure pump 26, in contrast to conventional techniques requiring a high-pressure pump to fit inside in a swage body that is itself smaller than a well diameter. Yet another advantage of the hydraulic swage system 10 of the present invention over conventional techniques is a reduced time to generate sufficient lateral pressure to repair a well casing 22 due to higher efficiency of operation due to gravitational pressure, more powerful power supplies 28 available to drive a high-pressure pump 26, and fast transmission of pressurized fluid 34 from the above-ground source of pressurized fluid 16 down a well shaft to the swage body 12.

Yet another advantage of the present invention is the ease of replacing or repairing critical portions of the system. For example, several high-pressure pumps 26 and power supplies 28 of varying capacities may be taken to a remote well location for replacement of malfunctioning components or to increase capacity as needed, without requiring removal of the swage body 12 from a well 20. Conventional systems, on the other hand, provide limited flexibility for replacing or exchanging components as needed, and may require removal of a swage from a well to repair or replace failed pumps or pump motors.

Preferably, the hydraulic swage system 10 further comprises a directional valve 32 coupled to the above-ground source of pressurized fluid 16 and the first tube 18, with the directional valve 32 having a first position for coupling the first tube 16 to the above-ground source of pressurized fluid 16. The directional valve 32 may be used to alternately supply pressurized fluid 34 to the swage body 12 via the first tube 18 or to release the first tube 18 from the above-ground source of pressurized fluid 34 and allow the release of pressure in the first tube 16 and swage body 12. However, it should be understood that it is within the spirit and scope of the present invention that a directional valve 32 not be used, as long as a release of pressure in the first tube 18 may be obtained. For example, the first tube 16 may simply be physically detached from the above-ground source of pressurized fluid 16 when a release of pressure is desired.

The hydraulic swage system 10 preferably further comprises a second tube 38 coupled to both the directional valve 32 and the swage body 12 so that the pressurized fluid 34 entering the swage body 12 from the second tube 38 returns the at least one movable member 14 laterally inward toward the swage body 12. The directional valve 32 preferably has a second position for coupling the second tube 38 to the above-ground source of pressurized fluid 16. However, it should be understood that significant benefit may be obtained by not having a second tube 38 receiving pressurized fluid 34 to return the at least one movable member 14 inward toward the swage body 12, as long as the movable members 14 may be returned from a laterally outward extended position. For example, a set of hinged jaws 40 serving as the movable members 14 as depicted in FIGS. 1-5 having a normally closed position due to gravity may have sufficient mass to return to a closed position by downward gravitational force when the first tube 18 is decoupled from the above-ground source of pressurized fluid 16.

To further improve over conventional systems, it is preferred that at least one of the first tube 18 and the second tube 38 is rigid, and preferably comprises a plurality of rigid segments 42. By having the swage body 12 coupled to a rigid tube 18 or 38, the swage body 12 may be lowered, raised, rotated, and positioned within the well 20 via manipulating the rigid tube 18 or 38 from an above-ground position. By forming the rigid tube 18 or 38 from a series of rigid segments 42, a tube of proper length may be assembled at the well location and modified for repairs at varying depths.

It is also preferred that the first tube 18 and the second tube 38 are concentric, as depicted in FIGS. 1, 4 and 5. Using concentric tubes 18 and 38 allows the multiple functions of raising, lowering, rotating, positioning, and operating the swage body 12 within a well 20 to be accomplished by manipulating only the exterior of the concentric tubing 18 and 38 outside the well 20. This solves a problem of conventional systems that may require a first line to a swage body to operate the swage, a second line fastened to a crane to raise and lower the swage body, and a third component such as a pipe to rotate or position the swage body inside a well. Although it is preferred that the first tube 18 and the second tube 38 are concentric, it is within the spirit and scope of the present invention that the first tube 18 and the second tube 38 are not concentric; for example, the first tube 18 and the second tube 38 may be in a side-by-side arrangement or may be spaced apart.

As depicted in each of FIGS. 1-5, in a preferred embodiment of the present invention the swage body 12 defines a cavity 44. The swage body 12 further comprises a piston 46 positioned in the cavity 44 and coupled to at least one of the at least one movable member 14 for moving the movable member 14. Pressurized fluid 34 entering the cavity 44 moves the piston 46 which in turn actuates the movable members 14, generating laterally outward pressure to the well casing 22.

Preferably, the piston 46 separates the cavity 44 into a first portion 48 and a second portion 50, and the hydraulic swage system 10 further comprises a directional valve 32 for directing the pressurized fluid 34 from the above-ground source of pressurized fluid 16 into one of the first portion 48 and the second portion 50 of the cavity 44. Although the directional valve 32 is depicted in FIG. 1 as interposed between the above-ground source of pressurized fluid 16 and a first tube 18 and second tube 38, which in turn are coupled to the first portion 48 and the second portion 50 of the cavity 44, the directional valve may be located at any position that allows direction of the pressurized fluid 34 into the first portion 48 or the second portion 50 of the cavity 44. For example, the directional valve 32 may be located proximate the swage body 12.

Preferably, the hydraulic swage system 10 of the present invention further comprises a fluid reservoir 58, the above-ground source of pressurized fluid 16 is a pump 26 supplied by the fluid reservoir 30, and the directional valve 32 couples one of the first tube 18 and the second tube 38 to the pump 26 for providing the pressurized fluid 34 to said cavity 44 and the other of the first tube 18 and the second tube 38 to the fluid reservoir 58 for recovering fluid 36 from the cavity 44. By operating the valve 32 to alternately connect one tube 18 or 38 to the above-ground source of pressurized fluid 16 and the other tub 18 or 38 to the fluid reservoir 30, as one tube is receiving pressurized fluid 34 the other is releasing pressure and returning non-pressurized fluid 36 to the fluid reservoir 58 for reuse.

In a preferred embodiment of the present invention as depicted in FIGS. 1-5, the at least one movable member 14 is a plurality of jaws 40 pivotally coupled to the swage body 12, and the hydraulic swage system 10 further comprises a wedge 52 attached to the piston 46 so that a movement of the piston 46 causes the wedge 52 to rotate each of the plurality of jaws 40 outward from the swage body 12. FIGS. 4 and 5 depict the current embodiment of the present invention in two states of operation: with the jaws closed in FIG. 4 and with the jaws open in FIG. 5. The shaded areas of the first tube 18, second tube 38, and first portion 48 and second portion 50 of the cavity 44 indicate pressurized fluid 34 while the non-shaded areas indicate non-pressurized fluid 36.

Although FIGS. 1-5 depict the at least one movable member 14 as a plurality of hinged jaws 40, it should be understood that substantial benefits may be obtained by the at least one movable member 14 not being a plurality of jaws 40, as long as the at least one movable member 14 may exert laterally outward pressure. For example, the at least one movable member 14 may be a plurality of press segments (not shown) mounted to extend radially outward from a side swage body 12 to contact a well casing 22, or may be any other mechanism where a member 14 moves relative to the swage body 12 to exert laterally outward pressure.

Turning now to FIG. 4, a portion of the hydraulic swage system 10 typically lowered into a well 20 is shown. The first tube 18 and first portion 48 of the cavity 44 above the piston 46 contain non-pressurized fluid 38. The second tube 38 and second portion 50 of the cavity 44 below the piston 46 contain pressurized fluid 34 from the above-ground source of pressurized fluid 16. The pressure differential between the first portion 48 and the second portion 50 of the cavity 44 results in the piston 46 being raised toward the top of the cavity 44. The wedge 52, coupled to the piston 46 is also in an upward position so that a narrow portion 54 of the wedge 52 is proximate the jaws 40. As a result, the jaws 40 are closed.

In contrast, FIG. 5 depicts first tube 18 and the first portion 48 of the cavity 44 containing pressurized fluid 34, and the second tube 38 and second portion 50 of the cavity 44 containing non-pressurized fluid 38. Because the first portion 48 of the cavity 44 above the piston 46 is at a higher pressure than the second portion 50 of the cavity 44 below the piston 46, the piston is driven to the bottom of the cavity 44. The wedge 52 is therefore extended downward so that a wide portion 56 of the wedge 52 is proximate the jaws 40, exerting laterally outward force on the jaws and separating the jaws 40.

Although FIGS. 4 and 5 depict the wedge 52 lowered to actively separate the jaws 40 and raised to allow gravity to close the jaws 40, it is within the spirit and scope of the present invention that the wedge 52 be coupled to the jaws 40 so that the jaws 40 are pulled closed by the wedge 52 when the wedge 52 is raised. For example, the jaws 40 and wedge 52 may have an interlocking structure so that outward force is exerted on the jaws 40 as the wedge 52 is lowered and inward force is exerted on the jaws 40 as the wedge 52 is raised.

### Method of Operation

In accordance with an embodiment of the present invention, a method of repairing well casings is described with reference to FIG. 1. It comprises the steps of: providing a hydraulically operated swage body 12 comprising at least one movable member 14 for exerting pressure laterally outward from the swage body 12; and providing an above-ground source of pressurized fluid 16. The method further comprises the steps of coupling a first end of a first tube 18 to the swage body 12; lowering the swage body 12 into a well 20 having a casing 22; and supplying pressurized fluid 34 from the above-ground source of pressurized fluid 16 into a second end of the first tube 18 SO that the at least one movable member 14 exerts laterally outward pressure on the well casing 14, as illustrated in FIGS. 2 and 5.

Returning to FIG. 1, the method of repairing well casings preferably further comprises the steps of: providing a plurality of segments of rigid tubing 42; forming the first tube 18 by connecting at least two of the plurality of segments of rigid tubing 42; and manipulating the first tube 18 to position the swage body 12 relative to the well casing 22.

In an alternate embodiment of the present invention, the method of repairing well casings comprises the steps of: coupling a first end of a second tube 38 to the swage body 12, as in FIGS. 1-5; supplying pressurized fluid 34 from the above-ground source of pressurized fluid 16 (see FIG. 1) into a second end of the second tube 38 so that the at least one movable member 14 releases the laterally outward pressure from the well casing 22, as illustrated in FIG. 4.

Preferably, the method of repairing well casings in accordance with the present embodiment further comprises providing a directional valve 32 coupled to the above-ground source of pressurized fluid 16 and to both the second end of the first tube 18 and the second end of the second tube 38, and setting the directional valve 32 to supply the pressurized fluid 34 from the above-ground source of pressurized fluid 16 to one of the first tube 18 and the second tube 38. The directional valve 32 may be used to operate the swage body 12, either causing the movable members 14 to press outward on a well casing 22 by directing pressurized fluid 34 in the first tube 18 or causing the movable members 14 to return to a non-pressing position by directing pressurized fluid 34 into the second tube 38.

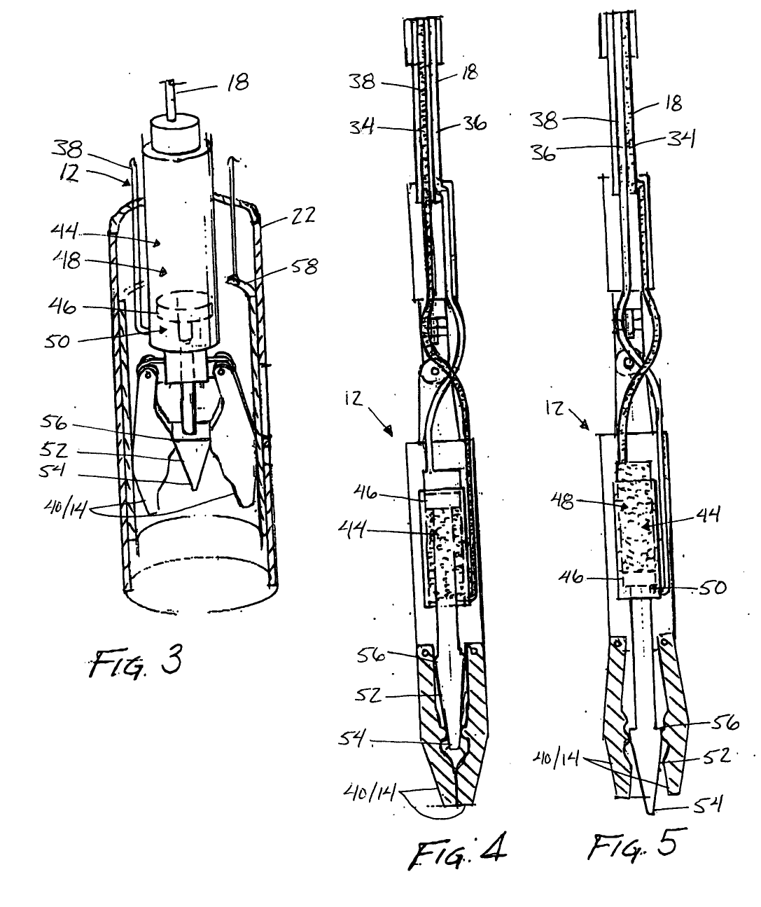

When a damaged portion 24 of a well casing 22 has been at least partially repaired in accordance with the present invention, the well casing may further benefit from the addition of a lining 60 over the damaged portion, as shown in FIG. 3. This is accomplished by lowering a lining 60 into the well 20 and supplying pressurized fluid 34 from the above-ground source of pressurized fluid 16 into a second end of the first tube 18 so that the at least one movable member 14 exerts laterally outward pressure on the lining 58 to patch a damaged portion 24 of the well casing 22.

1. A hydraulic swage system for repairing well casings, comprising, in combination:
a swage body comprising at least one movable member for exerting pressure laterally outward from said swage body;
an above-ground source of pressurized fluid coupled to said swage body; and
a first tube coupled to both said swage body and said above-ground source of pressurized fluid so that said pressurized fluid entering said swage body from said first tube moves said at least one movable member laterally outward from said swage body.

2. The system of claim 1 wherein said first tube is rigid for positioning said swage body.

3. The system of claim 1 wherein said first tube comprises a plurality of rigid segments.

4. The system of claim 1, further comprising a directional valve coupled to both said above-ground source of pressurized fluid and said first tube, said directional valve having a first position for coupling said first tube to said above-ground source of pressurized fluid.

5. The system of claim 4, further comprising a second tube coupled to both said directional valve and said swage body so that said pressurized fluid entering said swage body from said second tube returns said at least one movable member laterally inward toward said swage body, said directional valve having a second position for coupling said second tube to said above-ground source of pressurized fluid.

6. The system of claim 5 wherein at least one of said first tube and said second tube is rigid for positioning said swage body.

7. The system of claim 5 wherein at least one of said first tube and said second tube comprises a plurality of rigid segments.

8. The system of claim 5 wherein said first tube and said second tube are concentric.

9. The system of claim 1 wherein said swage body defining a cavity and further comprising a piston positioned in said cavity and coupled to at least one of said at least one movable member for moving said movable member.

10. The system of claim 9 wherein said piston separates said cavity into a first portion and a second portion, further comprising a directional valve for directing said pressurized fluid from said above-ground source of pressurized fluid into one of said first portion and said second portion of said cavity.

11. The system of claim 9 wherein said at least one movable member is a plurality of jaws pivotally coupled to said swage body, and further comprising a wedge attached to said piston so that a movement of said piston causes said wedge to rotate each of said plurality of jaws outward from said swage body.

12. A hydraulic swage system for repairing well casings, comprising, in combination:
a swage body defining a cavity and comprising at least one movable member for exerting pressure laterally outward from said swage body;
a piston positioned in said cavity and coupled to at least one of said at least one movable member, said piston separating said cavity into a first portion and a second portion;
an above-ground source of pressurized fluid coupled to said swage body;
a first tube coupled to said first portion of said cavity for coupling said above-ground source of pressurized fluid to said first portion of said cavity; and
a second tube coupled to said second portion of said cavity for coupling said above-ground source of pressurized fluid to said second portion of said cavity, at least one of said first tube and said second tube comprises a plurality of rigid segments.

13. The system of claim 12, further comprising a fluid reservoir and a directional valve, said above-ground source of pressurized fluid is a pump supplied by said fluid reservoir, said directional valve couples one of said first tube and said second tube to said pump for providing said pressurized fluid to said cavity and the other of said first tube and said second tube to said fluid reservoir for recovering fluid from said cavity.

14. The system of claim 12 wherein said first tube and said second tube are concentric.

15. A method of repairing well casings, comprising the steps of:
providing a hydraulically operated swage body comprising at least one movable member for exerting pressure laterally outward from said swage body;
providing an above-ground source of pressurized fluid;
coupling a first end of a first tube to said swage body;
lowering said swage body into a well having a casing; and
supplying pressurized fluid from said above-ground source of pressurized fluid into a second end of said first tube so that said at least one movable member exerts laterally outward pressure on said casing.

16. The method of claim 15, further comprising the steps of:
providing a plurality of segments of rigid tubing;
forming said first tube by connecting at least two of said plurality of segments of rigid tubing; and
manipulating said first tube to position said swage body relative to said casing.

17. The method of claim 15, further comprising the steps of:
coupling a first end of a second tube to said swage body; and
supplying pressurized fluid from said above-ground source of pressurized fluid into a second end of said second tube so that said at least one movable member releases said laterally outward pressure from said casing.

18. The method of claim 17, further comprising the steps of:
providing a directional valve coupled to said above-ground source of pressurized fluid and to both said second end of said first tube and said second end of said second tube; and
setting said directional valve to supply said pressurized fluid from said above-ground source of pressurized fluid to one of said first tube and said second tube.

19. The method of claim 17, further comprising the steps of:
lowering a lining into said well; and
supplying pressurized fluid from said above-ground source of pressurized fluid into a second end of said first tube so that said at least one movable member exerts laterally outward pressure on said lining to patch a damaged portion of said casing.

20. The method of claim 15 wherein said fluid is water.
